(19) United States
(12) Patent Application Publication
(10) Pub. No.: US 2015/0282431 A1
(43) Pub. Date: Oct. 8, 2015

(54) PLANT RECOVERY AND PLANTING OF MISCANTHUS

(71) Applicant: Ingo DREHER, Balgheim (DE)

(72) Inventor: Ingo Dreher, Balgheim (DE)

(21) Appl. No.: 14/439,501

(22) PCT Filed: Oct. 23, 2013
(86) PCT No.: PCT/DE2013/100365

§ 371 Date: Apr. 29, 2015

(30) Foreign Application Priority Data
Oct. 31, 2012 (DE) 10 2012 110 420.4

(51) Int. Cl. A01G 1/00; A01C 14/00

(52) U.S. Cl. CPC A01G 1/001; A01C 14/00

(57) ABSTRACT

Disclosed is a method for recovering planting material and planting miscanthus in which at least one rhizome of the miscanthus plant is introduced into a field and at least one miscanthus plant shoots from said at least one rhizome. In order to introduce the at least one rhizome into the field, a shaped member that includes the at least one rhizome and dirt surrounding the at least one rhizome is planted in the field.

The invention relates to a method for recovering plant material and planting of miscanthus, whereby at least one rhizome of the miscanthus plant is introduced into a cultivated area and at least one miscanthus plant sprouts from the at least one rhizome.

Further, the invention relates a shaped body, formed from soil and at least one completely enclosed rhizome of the miscanthus plant.

The miscanthus plant has a steadily increasing importance in the agricultural production of biomass. The giant grass grows up to 4 m over the course of a year and then dries over the winter months. The grass can be harvested in the spring and used as biomass. Miscanthus is a permanent crop that can be used annually for 20 years and yields a profit. The plant material recovery and planting of miscanthus can occur today according to two methods. In a first method, plantlets, about 20 cm in size, that have been raised and crossed in an in vitro laboratory are planted out. This process is relatively expensive because of the costly raising process. In the second method, individual roots of the miscanthus plant, so-called rhizomes, are planted in the soil. The miscanthus plant then grows from the rhizomes. To recover the rhizomes a harvested cultivated area is preferably tilled with a cultivator or a harrow. In so doing, the rhizomes come loose out of the soil and can be collected. Because miscanthus is a plant that spreads by roots, an approximately five times larger cultivated area can be produced from rhizomes obtained in this way. However, propagation on the basis of rhizomes is labor-intensive. In both cultivation methods, the plantlets or rhizomes are placed in a regular grid. The distance between the plantlets or rhizomes should be preferably 1 m square. A disadvantage of the known method for plant material recovery and planting of miscanthus is that high losses due to winter kill particularly in the first year are deplorable and therefore the biomass yield is low. Moreover, the plant material recovery is associated with high costs or is labor-intensive.

The object of the present invention in this respect is to improve the plant material recovery and planting of miscanthus.

To achieve the object, the invention in conjunction with the preamble of claim 1 is characterized in that for introducing the at least one rhizome into the cultivated area, a shaped body, having the at least one rhizome and soil surrounding the at least one rhizome, is planted in the cultivated area.

The particular advantage of the invention is that miscanthus can be propagated in an especially cost-effective manner with the aid of the shaped body formed from soil and at least one rhizome. In particular, the crossing of plants in the in vitro laboratory and their growing or labor-intensive recovery of individual rhizomes become superfluous. It has turned out, moreover, that the growth rate is surprisingly high and the losses due to winter kill in the first year are below average.

The invention therefore proposes a fundamentally new method for plant material recovery and planting of miscanthus. The shaped body, which, for example, can have a block shape, a cylindrical shape, or a truncated cone shape, hereby replaces the plantlets or separated rhizomes.

According to a preferred embodiment of the invention, the shaped bodies are removed from a rhizome cluster formed in the cultivated area. Because miscanthus is a plant that spreads by roots, an area penetrated by roots forms in the cultivated area close to the surface within a few years. Numerous rhizomes which can be used for plant material recovery and new planting are therefore present in an area with a 60 cm diameter around the original plant. The shaped bodies are obtained from precisely these areas, the so-called rhizome cluster. Advantageously, the shaped bodies are therefore obtained directly from an already existing cultivated area. The shaped bodies are therefore waste products from the standard cultivation of the cultivated area. A separate growing or recovery in nurseries or special facilities is not necessary.

According to a refinement of the invention, the external dimensions of the shaped body are selected so that the shaped body with a sufficiently high probability contains at least one undamaged, completely preserved rhizome of the miscanthus plant. Field trials have shown in this regard that in the case of a block-like shaped body, for example, an edge length of 10 to 20 cm is sufficient to find almost certainly at least one undamaged rhizome in the shaped body. Preferably, a cube geometry with an edge length of 15 cm is used. A rhizome in this case is formed from a main root body, which substantially defines the volume of the rhizome and is approximately thumb-sized, and of hair roots projecting from the main root body, which are used in particular to take up nutrients and to supply the rhizome with water. Advantageously, the probability of taking root improves and losses due to winter kill are reduced, if a completely preserved rhizome with the main root body and hair roots are enclosed in the shaped body.

According to a refinement of the invention, to obtain consistently formed shaped bodies, at least two longitudinal cuts, oriented substantially parallel to one another, and then a plurality of likewise substantially parallel cross cuts are made in the ground. The longitudinal cuts and the cross cuts have a predetermined minimum depth and are arranged crossing one another. Further, a bottom cut is made, whereby a bottom side of the shaped body, which is opposite to a top side, formed by a surface of the cultivated area, of the shaped body is formed by the bottom cut. The shaped body can be produced advantageously especially simply in this way. In particular the regular form of the shaped body allows a high degree of automation and good logistic properties. For example, a substantially block-like shaped body can be produced, when the longitudinal and cross cuts are oriented perpendicular to one another and the bottom cut occurs substantially parallel to the surface of the cultivated area.

If within the scope of the invention geometric forms, for example, a block shape, cylindrical shape, or truncated cone shape are used to describe the geometry or the relative position of surfaces, cuts, or the like to one another is explained, the scope of the agricultural use is to be considered and a spacious scale is to be applied in regard to the required accuracy or correspondence. A block shape then exists, for example, when within the scope of the working accuracy of agricultural machines or manual garden work, opposite side surfaces are oriented substantially parallel to one another. Likewise, the special working practices and machines used in agriculture are to be taken into account in evaluating the parallelism or other geometric specifications. A block form within the meaning of the application also exists, for example, when within the scope of processing, drying, subsequent transport, or storage of the shaped body the corners or edges break off or are deformed.

According to a refinement of the invention, the longitudinal cuts and/or the cross cuts and/or the bottom cut are made with an agricultural rotary hoe, with a plow, or with a cutter. Advantageously, when these devices are used, agricultural machinery, available in any event on a farm, can be used for the plant material recovery and planting of miscanthus. There are no high investment costs. In addition, the cultivation can occur economically, because a plurality of shaped bodies are produced within a short time. In this case, the use of a rotary hoe, plow, or cutter represents a fundamental departure from current cultivation methods. The current state of science and technology, on the contrary, is to pull the rhizomes out of the ground with the cultivator or a similar cultivating machine. It is explicitly not recommended to loosen the rhizomes with a cutter, because otherwise there is a predominant risk of damaging the rhizome and the success of the plant material recovery is jeopardized.

According to a refinement of the invention, the minimum depth for the longitudinal cut and cross cut is selected so that the bottom side of the shaped body is formed below a typical growth depth of the rhizome cluster. Advantageously, the probability of completely preserving the rhizome with its hair roots is increased hereby. In particular, the possibility of planting the shaped body improves and losses especially during the first year are reduced or prevented. Tests have shown that a cutting depth of 15 cm is usually sufficient, because the typical growth depth of the rhizome cluster is approximately 10 to 12 cm. Local deviations in growth depth in this case have only a minor effect on the probability of taking root or winter kill losses of the miscanthus plant. This also applies when the rhizome has been slightly damaged in the area of individual hair roots.

According to a refinement of the invention, a plurality of shaped bodies are planted in a regular planting pattern, particularly a checkerboard pattern, in the cultivated area. The shaped bodies in this case have a distance of 30 to 70 cm, preferably a distance of 40 to 50 cm, and especially preferably a distance of 45 cm to one another. Field trials have shown that with the indicated distance ranges a crowded rhizome cluster is formed in the cultivated area within a few years; on the one hand, the rhizome cluster results in a miscanthus with good growth properties, has low winter kill losses, and offers a consistently high yield over many years. On the other hand, the shaped bodies can be obtained in an especially simple manner when the rhizome clusters are crowded. There are then no areas without a rhizome, so that a previous examination of the soil or checking of the shaped body for an enclosed rhizome is unnecessary. Overall, because of this the plant material recovery is simplified with the result that the method can be used in an especially economic manner.

According to a refinement of the invention, during the obtainment of shaped bodies from a crowded rhizome cluster, shaped bodies, block-shaped in cross section, with an edge length of approximately 15 cm are formed by making crossing longitudinal cuts and cross cuts, spaced 15 cm from one another, in the soil. Each two adjacent longitudinal cuts and each two adjacent cross cuts hereby form a longitudinal row arrangement of shaped bodies or a cross row arrangement of shaped bodies, respectively. Next, a plurality of shaped bodies are obtained from each two adjacent longitudinal row arrangements and from each two adjacent cross row arrangements with the formation of a bottom cut. Rhizomes remain in the cultivated area next to these two adjacent longitudinal row arrangements and next to these two adjacent cross row arrangements. The miscanthus plant can subsequently sprout from these rhizomes. Advantageously, the remaining rhizomes have a macroscopic distance of 45 cm in each case in the longitudinal and cross direction, so that especially good properties are created here for the growth the miscanthus plant. In addition, a plurality of shaped bodies can be obtained. It is possible in this respect to use the cultivated area for many years for cultivating miscanthus and at the same time to remove shaped bodies with surplus rhizomes from this cultivated area. The cultivated area can be successfully increased many times over within a short time in this way.

According to another aspect, the invention provides a shaped body, obtained from a rhizome cluster of the miscanthus plant, with a substantially block-shaped basic form. The shaped body comprises soil and at least one substantially completely preserved miscanthus plant rhizome, formed by a main root body and hair roots projecting therefrom. The basic body has a top side, a bottom side opposite to the top side, and four connecting sides, which are provided between the top side and bottom side. A length, width, and depth of the basic body in each case are between 10 and 20 cm.

The particular advantage of the invention is that the shaped bodies with the rhizome of the miscanthus plant can be obtained in a markedly economic manner and a new miscanthus plant can grow from the at least one rhizome of the shaped body. In this respect, the financial and operational cost during the plant material recovery is reduced. Moreover, the winter kill losses especially during the first year of growing miscanthus can be reduced.

Exemplary embodiments will be explained in greater detail below with use of drawings.

In the drawing:

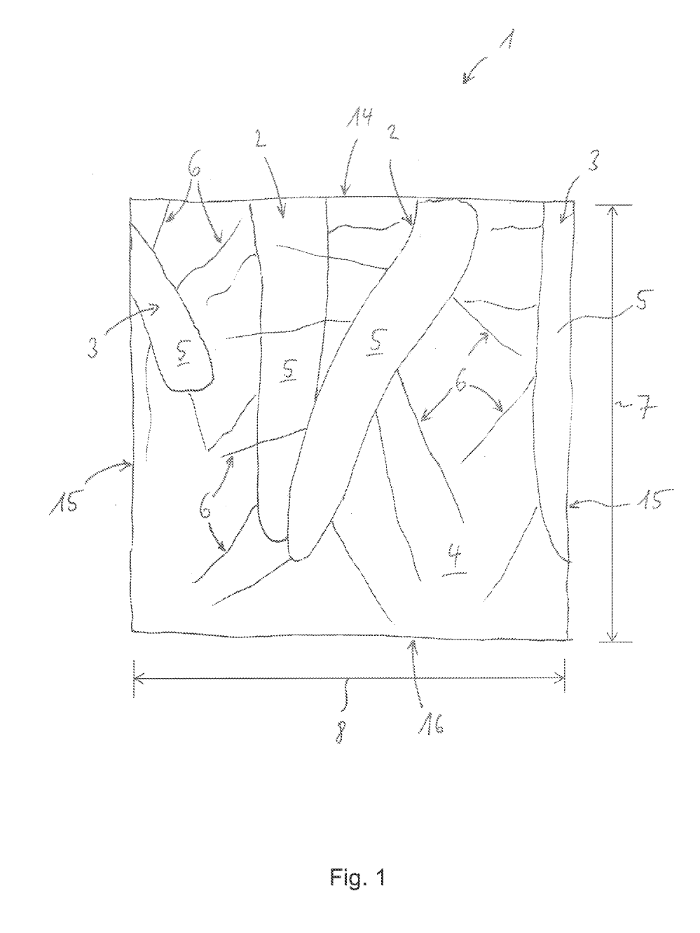

FIG. 1 shows a cross section through a substantially block-like shaped body;

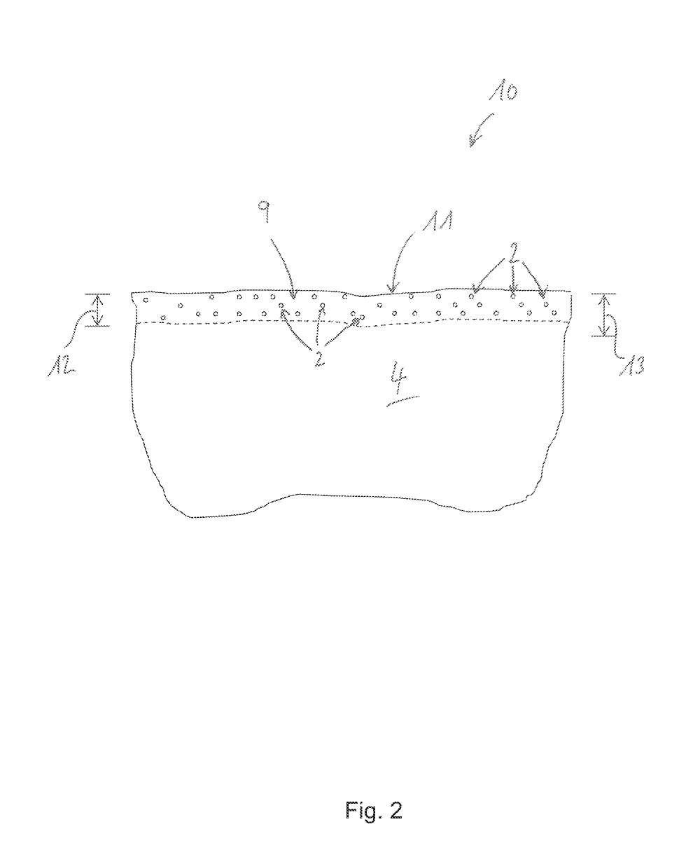

FIG. 2 shows a cross section through the soil with a rhizome cluster close to the surface;

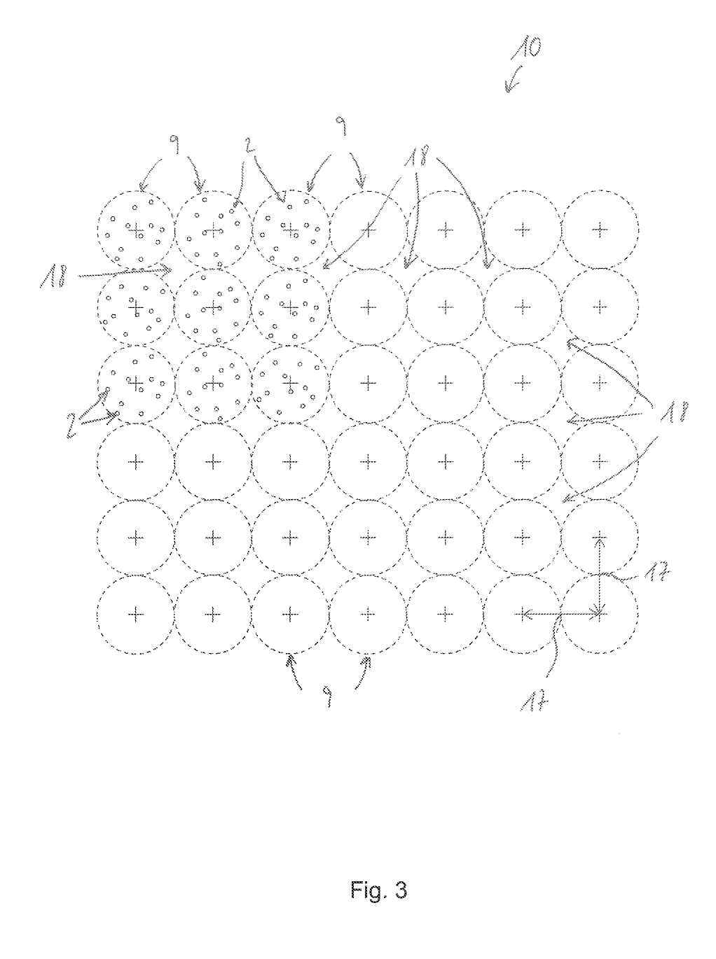

FIG. 3 shows a top plan view of a rhizome cluster of the miscanthus plant in the case of classic cultivation (state of the art);

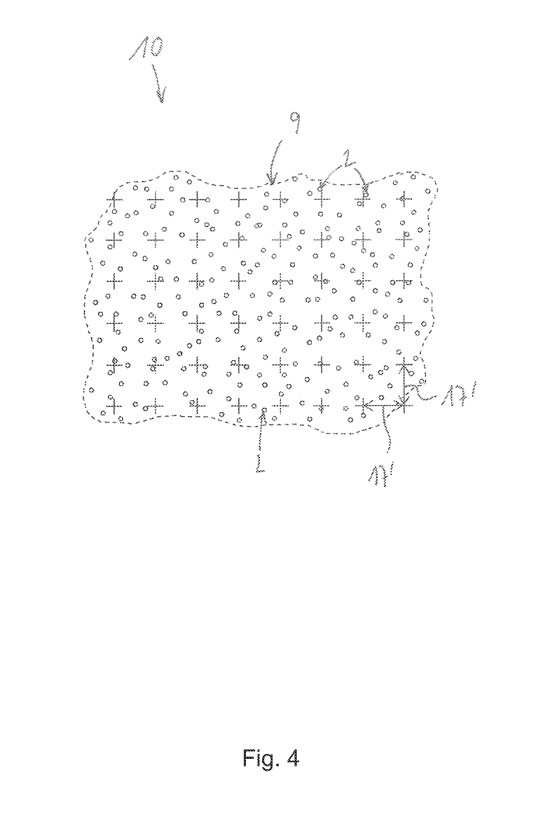

FIG. 4 shows a top plan view of a crowded rhizome cluster of the miscanthus plant, formed according to a cultivation method of the invention; and

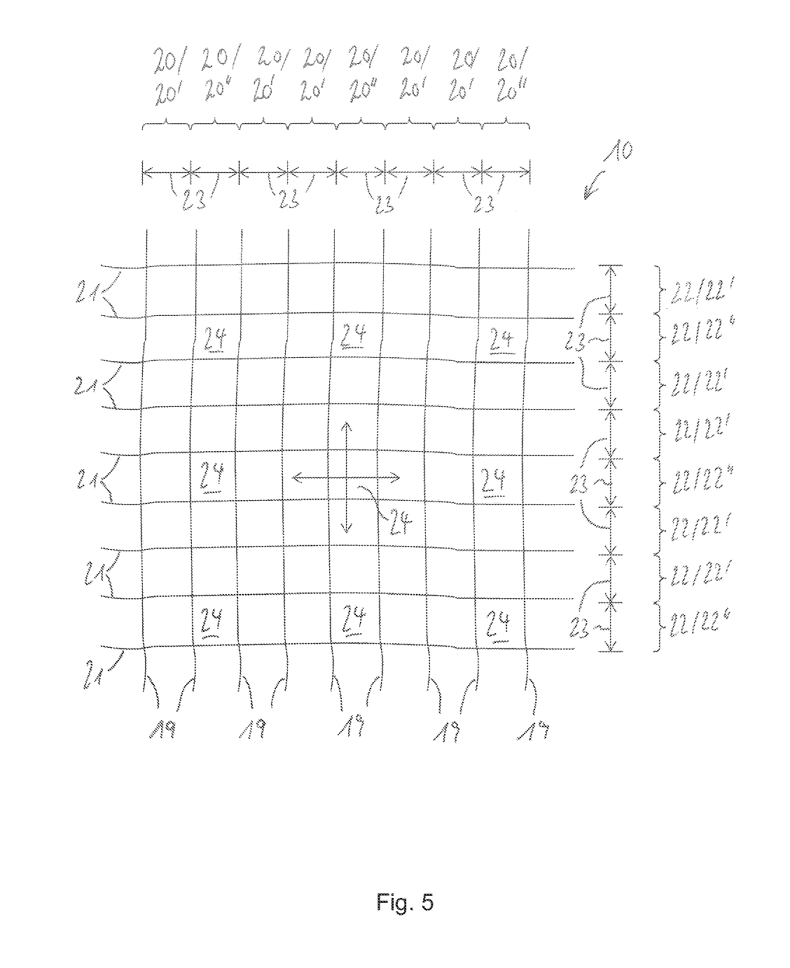

FIG. 5 shows a schematic diagram of a plant material recovery method of the invention.

As a departure from previously used methods for plant material recovery and for culturing miscanthus, the invention provides for the miscanthus plant to be propagated with use of a shaped body 1. Shaped body 1, as shown in FIG. 1, has at least one rhizome of the miscanthus plant 2, 3 and soil 4 surrounding at least one rhizome 2, 3. Rhizome 2, 3 itself comprises a main root body 5 and a plurality of hair roots 6, projecting from main root body 5. Hair roots 6 serve in particular to take up nutrients and to supply rhizome 2, 3 with water. Shaped body 1 has a top side 14, a bottom side 16, and four connecting sides 15, which connect top side 14 and bottom side 16 to one another and are arranged in pairs parallel to one another.

In the present exemplary embodiment of the invention, shaped body 1 is formed in the shape of a block. It has a depth 7 and a width 8 corresponding to depth 7. Moreover, the length (not shown) corresponds substantially to depth 7 and width 8. For example, the edge length (depth 7, width 8, length) of shaped body 1 is approximately 15 cm. In this case, the edge length is selected so that shaped body 1 contains with sufficient probability at least one completely preserved rhizome 2 of the miscanthus plant. Typically, then in addition a plurality of incompletely preserved rhizomes 3, for example, rhizomes 3 damaged, particularly cut, during the obtainment of shaped body 1, are included. Depending on the quality of rhizome cluster 9, the edge length of shaped body 1 can be between 10 and 20 cm, whereby the cube shape is optional and any block shape can be selected.

The block-shaped structure of shaped body 1 is also only an example. Of course, the shaped body may have any desired geometry. For example, the shaped body can have a rectangular cross section or be formed in the shape of a cylinder or truncated cone.

FIG. 2 shows a cross section through a rhizome cluster 9 of the miscanthus plant. Rhizome cluster 9 is formed by a plurality of intact rhizomes 2 in the area near the surface of cultivated area 10. It extends from a surface 11 of cultivated area 10 in the area near the surface down to a growth depth 12, which is typically in the range of about 10 to 12 cm. Soil 4 below this is substantially free of rhizomes 2.

Shaped body 1 can be obtained from rhizome cluster 9 in an especially simple way. To this end, shaped body 1 is cut out of rhizome cluster 9. A minimum depth 13 of the cut, which at the same time defines depth 7 of shaped body 1, is selected so that the cut is made below growth depth 12. It can be assured in this way that rhizomes 2 in the area of bottom side 16 remain largely undamaged and especially hair roots 6 as well are preserved completely or mostly completely.

FIG. 3 shows a top plan view of rhizome cluster 9, which is formed with the cultivation methods typical today and according to the state of the art. Because initially a plurality of plantlets or rhizomes are planted at a grid distance 17 of 1×1 meters in cultivated area 10 and the roots of the miscanthus plant grow in a diameter range of about 50 to 60 cm, individual rhizome clusters 9 form, whereby open spaces 18 in which there are no rhizomes are provided extending in a planar manner between rhizome clusters 9. A thus designed cultivated area 10 is problematic for the plant material recovery of the invention insofar as shaped bodies obtained in the area of open spaces 18 cannot be used, because then no rhizomes 2, 3 and particularly no completely preserved rhizomes 2 are present in shaped bodies 1. Shaped bodies 1 with completely preserved rhizomes 2 can therefore be obtained solely in the area of locally formed rhizome clusters 9. During the creation of shaped bodies 1, the soil condition and the presence of rhizomes 2, 3 must be checked. In this respect, selection of shaped bodies 1 is necessary.

If instead grid dimension 17 is formed in the range of 30 to 70 cm, preferably in the range of 40 to 50 cm, and especially preferably with 45 cm, a single crowded rhizome cluster 9 forms over the entire cultivated area 10, as shown in FIG. 4. In this case, shaped bodies 1 can be removed in any place of cultivated area 10, whereby there is always a sufficiently high probability that at least one completely preserved rhizome 2 is enclosed in shaped body 1. At the same time, it turned out that the biomass yield in the case of the small cluster distance 17 is consistently high and crowded miscanthus growth results. In this respect, cluster dimension 17 in the range of 30 to 70 cm is equally advantageous for propagating the miscanthus plant and for its profitable cultivation.

A special method for recovering plant material according to FIG. 5 provides that cultivated area 10 is first provided with a plurality of longitudinal cuts 19, whereby longitudinal cuts 19 are made substantially parallel to one another and two adjacent longitudinal cuts 19 in their middle in each case form a longitudinal row arrangement 20. Next, a plurality of cross cuts 21 are formed, which are also parallel to one another and cross longitudinal cuts 19. In this case, a cross depression 22 is formed between two neighboring cross cuts 21. Cultivated area 10 as a result acquires a checkerboard pattern in the top plan view, whereby adjacent longitudinal cuts 19 and adjacent cross cuts 21 each have, for example, a distance of 15 cm.

To form shaped bodies 1, then in the area of two adjacent longitudinal row arrangements 20′ a bottom cut substantially parallel to top side 14 of shaped bodies 1 is made with the result that the thus formed shaped bodies 1 can be separated and removed from cultivated area 10. The bottom cut is made in a similar way in the area of two adjacent cross row arrangements 22. Then the thus formed shaped bodies 1 can be removed here as well. As a result, a growth area 24 of cultivated area 10 is preserved in each third longitudinal roll arrangement 20″ and in each third cross row arrangement 22″. In the next growth cycle, a miscanthus plant sprouts from this growth area 24, which with a sufficient probability also has a completely preserved rhizome 2.

Thus, longitudinal cuts 19 and cross cuts 21 have a distance 23 of 15 cm, and growth areas 24 are located in a regular pattern with grid dimension 17 of 45 cm. As set forth above, this is optimal for cultivating miscanthus in cultivated area 10. The edge length of growth areas 24 is approximately 15 cm. Optionally, in the area of longitudinal row arrangement 20′ and cross row arrangement 22′, in which shaped bodies 1 were removed from cultivated area 10, arising trough-shaped depressions can be filled by bringing in soil, sand, or any other fill materials.

1. A method for recovering plant material and planting of miscanthus, whereby at least one rhizome of the miscanthus plant is introduced into a cultivated area and at least one miscanthus plant sprouts from the at least one rhizome, characterized in that for introducing the at least one rhizome into the cultivated area, a shaped body, having the at least one rhizome and soil surrounding the at least one rhizome, is planted in the cultivated area.

2. The method according to claim 1, wherein to obtain the shaped body, the same is separated from a rhizome cluster formed in the cultivated area and removed.

3. The method according to claim 1, wherein the external dimensions of the shaped body are selected so that there is with a sufficiently high probability at least one undamaged, completely preserved rhizome of the miscanthus plant in the shaped body.

4. The method according to claim 1, wherein to obtain consistently formed shaped bodies, at least two longitudinal cuts, oriented substantially parallel to one another, with a predetermined minimum depth are made in the cultivated area, that then a plurality of substantially parallel cross cuts with the predetermined minimum depth are made in the cultivated area, whereby the longitudinal cuts and the cross cuts cross one another, and that then a bottom cut is made to loosen the shaped body, whereby a bottom side of the shaped body, which is opposite to a top side, formed by a surface of the cultivated area, of the shaped body, is formed by the bottom cut.

5. The method according to claim 1, wherein the longitudinal cuts and/or the cross cuts and/or the bottom cut are made with an agricultural rotary hoe and/or with a plow and/or with a cutter.

6. The method according to claim 1, wherein the minimum depth for the longitudinal cut and the cross cut is selected so that the bottom side of the shaped body is formed below a typical growth depth of the rhizome cluster.

7. The method according to claim 1, wherein a substantially block-like shaped body is formed as the consistently formed shaped body with a width between 10 and 20 cm, with a depth between 10 and 20 cm, and with a length between 10 and 20 cm.

8. The method according to claim 1, wherein a plurality of shaped bodies are planted in a regular planting pattern in the cultivated area, whereby the shaped bodies have a distance of 30 to 70 cm, preferably a distance of 40 to 50 cm, and especially preferably a distance of 45 cm to one another.

9. The method according to claim 1, wherein during the obtainment of shaped bodies from a cultivated area having a rhizome cluster, shaped bodies, block-shaped in cross section, with an edge length of 15 cm are formed, by providing crossing longitudinal cuts and cross cuts, spaced 15 cm apart, in the cultivated area, whereby each two adjacent longitudinal cuts form a longitudinal row arrangement of shaped bodies and each two adjacent cross cuts form a cross row arrangement of shaped bodies, and that shaped bodies are then obtained from each two adjacent longitudinal row arrangements and from each two adjacent cross row arrangements with the formation of a bottom cut, whereas further shaped bodies in a third longitudinal row arrangement, provided next to the two adjacent longitudinal row arrangements, and in a third cross row arrangement, provided next to the two adjacent cross row arrangements, remain in the cultivated area.

10. A shaped body, obtained from a rhizome cluster of the miscanthus plant, comprising soil and at least one substantially completely preserved rhizome of the miscanthus plant, formed by a main root body and hair roots projecting therefrom, with a substantially block-shaped basic form with a top side, a bottom side opposite to the top side, and four connecting sides between the top side and the bottom side and with a length, a width, and a depth of 10 to 20 cm in each case.

11. The shaped body according to claim 10, wherein there are no damaged, particularly cut main root body and preferably no cut hair roots on the bottom side.
